(19) United States
(12) Patent Application Publication
(10) Pub. No.: US 2022/0332893 A1
(43) Pub. Date: Oct. 20, 2022

(54) THERMOPLASTIC COMPOSITION, METHOD FOR THE MANUFACTURE THEREOF, AND ARTICLE PREPARED THEREFROM

(71) Applicant: SHPP GLOBAL TECHNOLOGIES B.V., Bergen op Zoom (NL)

(72) Inventors: Mian DAI, Shanghai (CN); Weiyun JI, Shanghai (CN); Liang SHEN, Shanghai (CN)

(21) Appl. No.: 17/638,273

(22) PCT Filed: Sep. 4, 2020
(86) PCT No.: PCT/IB2020/058262

§ 371 Date: Feb. 25, 2022

Related U.S. Application Data
(60) Provisional application No. 62/896,808, filed on Sep. 6, 2019.

(51) Int. Cl. C08G 73/10; C08J 3/00

(52) U.S. Cl. CPC C08G 73/1046; C08J 3/005; C08G 73/106; C08J 2379/08

(57) ABSTRACT

A thermoplastic composition includes 25 to 95 weight percent of a poly(etherimide); 5 to 70 weight percent of a polymer different from the poly(etherimide) that is partially miscible with the poly(etherimide); and 1 to 15 weight percent of a mineral filler having an average particle size of 0.1 to 10 micrometers; wherein each weight percent is based on the total weight of the composition. The thermoplastic composition can be prepared by melt-mixing the components of the composition. Articles including the composition are also described.

### CROSS REFERENCE TO RELATED APPLICATION

This application claims priority to and benefit of U.S. Provisional Application No. 62/896,808 filed Sep. 6, 2012, the contents of which is incorporated by reference herein in its entirety.

### BACKGROUND

Poly(etherimide)s (“PEIs”) are amorphous, transparent, high performance polymers having a glass transition temperature (“Tg”) of greater than 180° C. PEIs further have high strength, heat resistance, and modulus, and broad chemical resistance, and so are widely used in applications as diverse as automotive, telecommunication, aerospace, electrical/electronics, transportation, and healthcare. Compositions including poly(etherimide)s typically exhibit high temperature resistance, high stiffness, and high strength. However, the impact performance of the poly(etherimide) compositions is relatively poor.

Therefore, there remains a need in the art for poly(etherimide) compositions that can maintain the desirable high heat and mechanical performance while also exhibiting improved impact performance.

### SUMMARY

A thermoplastic composition includes 25 to 95 weight percent of a poly(etherimide); 5 to 70 weight percent of a polymer different from the poly(etherimide) that is partially miscible with the poly(etherimide); and 1 to 15 weight percent of a mineral filler having an average particle size of 0.1 to 10 micrometers; wherein each weight percent is based on the total weight of the composition.

In another aspect, a method of preparing the thermoplastic composition includes melt-mixing the components of the composition.

Articles including the thermoplastic composition are also described.

The above described and other features are exemplified by the following figures and detailed description.

### BRIEF DESCRIPTION OF THE DRAWINGS

The following figures represent exemplary embodiments.

FIG. 1 shows scanning electron microscopy (SEM) images of (a) the composition according to Comparative Example 1 and (b) the composition according to Comparative Example 2.

FIG. 2 shows scanning electron microscopy (SEM) images of (a) the composition according to Comparative Example 3, (b) the composition according to Example 1, (c) the composition according to Example 2.

FIG. 3 shows scanning electron microscopy (SEM) images of (a) the composition according to Comparative Example 4, (b) the composition according to Example 3, and (c) the composition according to Example 4.

FIG. 4 shows scanning electron microscopy (SEM) images of (a) the composition according to Comparative Example 5, and (b) the composition according to Comparative Example 6.

### DETAILED DESCRIPTION

The present inventors have unexpectedly found that the addition of a particular filler (also referred to herein as a “microfiller”) to a thermoplastic composition comprising poly(etherimide) and a polymer that is not fully miscible (i.e., is partially miscible) with the poly(etherimide) can significantly improve the impact performance of the composition, while maintaining the desirable thermal properties of the composition.

Accordingly, an aspect of this disclosure is a thermoplastic composition. The composition comprises a poly(etherimide). Poly(etherimide)s comprise more than 1, for example 2 to 1000, or 5 to 500, or 10 to 100 structural units of formula (1)

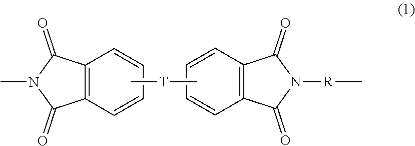

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In an aspect R is divalent group of one or more of the following formulas (2)

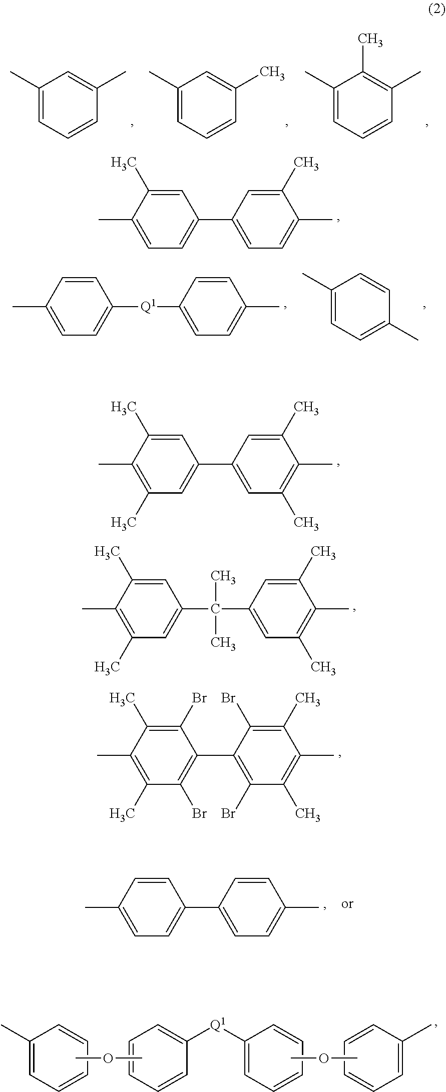

wherein Q¹ is —O—, —S—, —C(O)—, —SO₂—, —SO—, —P(R^{a})(═O)— wherein R^{a} is a C₁₋₂ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In an aspect R is m-phenylene, p-phenylene, or a diarylene sulfone, in particular bis(4,4′-phenylene)sulfone, bis(3,4′-phenylene)sulfone, bis(3,3′-phenylene)sulfone, or a combination thereof. In an aspect, at least 10 mole percent or at least 50 mole percent of the R groups contain sulfone groups, and in other aspects no R groups contain sulfone groups.

Further in formula (1), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups of formula (3)

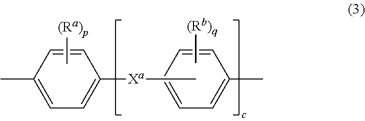

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

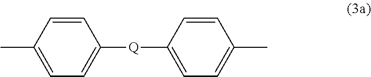

wherein Q is —O—, —S—, —C(O)—, —SO₂—, —SO—, —P(R^{a})(═O)— wherein R^{a} is a C₁₋₂ alkyl or C₆₋₁₂ aryl, or —C_{y}H_{2y}— wherein y is an integer from 1 to 5 or a halogenated derivative thereof (including a perfluoroalkylene group). In an aspect Z is a derived from bisphenol A, such that Q in formula (3a) is 2,2-isopropylidene.

In an aspect in formula (1), R is m-phenylene, p-phenylene, or a combination thereof, and T is —O—Z—O— wherein Z is a divalent group of formula (3a). Alternatively, R is m-phenylene, p-phenylene, or a combination thereof, and T is —O—Z—O— wherein Z is a divalent group of formula (3a) and Q is 2,2-isopropylidene. Such materials are available under the trade name ULTEM from SABIC. Alternatively, the poly(etherimide) can be a copolymer comprising additional structural poly(etherimide) units of formula (1) wherein at least 50 mole percent (mol %) of the R groups are bis(4,4′-phenylene)sulfone, bis(3,4′-phenylene)sulfone, bis(3,3′-phenylene)sulfone, or a combination thereof and the remaining R groups are p-phenylene, m-phenylene or a combination thereof; and Z is 2,2-(4-phenylene)isopropylidene, i.e., a bisphenol A moiety, an example of which is commercially available under the trade name EXTEM from SABIC.

In an aspect, the poly(etherimide) is a copolymer that optionally comprises additional structural imide units that are not poly(etherimide) units, for example imide units of formula (4)

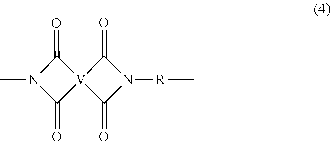

wherein R is as described in formula (1) and each V is the same or different, and is a substituted or unsubstituted C₆₋₂₀ aromatic hydrocarbon group, for example a tetravalent linker of the formulas

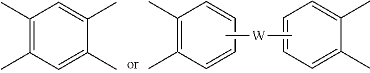

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mol % of the total number of units. In an aspect, no additional imide units are present in the poly(etherimide).

The poly(etherimide) can be prepared by any of the methods known to those skilled in the art, including the reaction of an aromatic bis(ether anhydride) of formula (5) or a chemical equivalent thereof, with an organic diamine of formula (6)

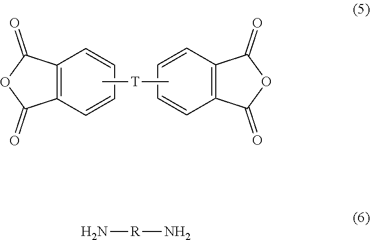

wherein T and R are defined as described above. Copolymers of the poly(etherimide)s can be manufactured using a combination of an aromatic bis(ether anhydride) of formula (5) and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of organic diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁₋₄ alkylated or poly(C₁₋₄)alkylated derivatives of any of the foregoing can be used, for example a polymethylated 1,6-hexanediamine. Combinations of these compounds can also be used. In an aspect the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination thereof.

The poly(etherimide) can also comprise a poly(siloxane-etherimide) copolymer comprising poly(etherimide) units of formula (1) and siloxane blocks of formula (7)

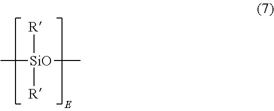

wherein E has an average value of 2 to 100, 2 to 31, 5 to 75, 5 to 60, 5 to 15, or 15 to 40, each R′ is independently a C₁₋₁₃ monovalent hydrocarbyl group. For example, each R′ can independently be a C₁₋₁₃ alkyl group, C₁₋₁₃ alkoxy group, C₂₋₁₃ alkenyl group, C₂₋₁₃ alkenyloxy group, C₃₋₆ cycloalkyl group, C₃₋₆ cycloalkoxy group, C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups can be fully or partially halogenated with fluorine, chlorine, bromine, or iodine, or a combination thereof. In an aspect no bromine or chlorine is present, and in an aspect no halogens are present. Combinations of the foregoing R groups can be used in the same copolymer. In an aspect, the polysiloxane blocks comprises R′ groups that have minimal hydrocarbon content. In an aspect, an R′ group with a minimal hydrocarbon content is a methyl group.

The poly (siloxane-etherimide)s can be formed by polymerization of an aromatic bis(ether anhydride) of formula (5) and a diamine component comprising an organic diamine (6) as described above or a combination of diamines, and a polysiloxane diamine of formula (8)

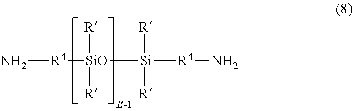

wherein R′ and E are as described in formula (7), and R⁴ is each independently a C₂-C₂₀ hydrocarbon, in particular a C₂-C₂₀ arylene, alkylene, or arylenealkylene group. In an aspect R⁴ is a C₂-C₂₀ alkylene group, specifically a C₂-C₁₀ alkylene group such as propylene, and E has an average value of 5 to 100, 5 to 75, 5 to 60, 5 to 15, or 15 to 40. Procedures for making the polysiloxane diamines of formula (8) are well known in the art.

In some poly(siloxane-etherimide)s the diamine component can contain 10 to 90 mole percent (mol %), or 20 to 50 mol %, or 25 to 40 mol % of polysiloxane diamine (8) and 10 to 90 mol %, or 50 to 80 mol %, or 60 to 75 mol % of diamine (6), for example as described in U.S. Pat. No. 4,404,350. The diamine components can be physically mixed prior to reaction with the bisanhydride(s), thus forming a substantially random copolymer. Alternatively, block or alternating copolymers can be formed by selective reaction of (6) and (8) with aromatic bis(ether anhydrides (5), to make polyimide blocks that are subsequently reacted together. Thus, the poly(siloxane-imide) copolymer can be a block, random, or graft copolymer. In an aspect the copolymer is a block copolymer.

Examples of specific poly(siloxane-etherimide)s are described in U.S. Pat. Nos. 4,404,350, 4,808,686 and 4,690,997. In an aspect, the poly(siloxane-etherimide) has units of formula (9)

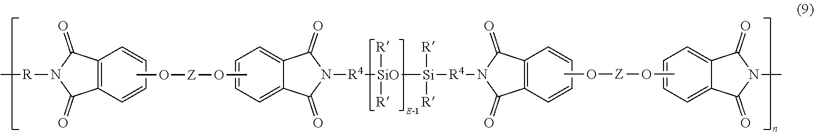

wherein R′ and E of the siloxane are as in formula (7), R and Z of the imide are as in formula (1), R⁴ is as in formula (8), and n is an integer from 5 to 100. In an aspect of the poly(siloxane-etherimide), R of the etherimide is a phenylene, Z is a residue of bisphenol A, R⁴ is n-propylene, E is 2 to 50, 5, to 30, or 10 to 40, n is 5 to 100, and each R′ of the siloxane is methyl.

The relative amount of polysiloxane units and etherimide units in the poly(siloxane-etherimide) depends on the desired properties and are selected using the guidelines provided herein. In particular, as mentioned above, the block or graft poly(siloxane-etherimide) copolymer is selected to have a certain average value of E and is selected and used in amount effective to provide the desired wt % of polysiloxane units in the composition. In an aspect the poly(siloxane-etherimide) comprises 10 to 50 wt %, 10 to 40 wt %, or 20 to 35 wt % polysiloxane units, based on the total weight of the poly(siloxane-etherimide).

The poly(etherimide) can have a melt index of 0.1 to 10 grams per minute (g/min), as measured by American Society for Testing Materials (ASTM) D1238 at 340 to 370° C., using a 6.7 kilogram (kg) weight. In an aspect, the poly(etherimide) has a weight average molecular weight (Mw) of 1,000 to 150,000 grams/mole (Dalton), as measured by gel permeation chromatography, using polystyrene standards. In an aspect the poly(etherimide) has an Mw of 10,000 to 80,000 Daltons. Such poly(etherimide)s typically have an intrinsic viscosity greater than 0.2 deciliters per gram (dl/g), or, more specifically, 0.35 to 0.7 dl/g as measured in m-cresol at 25° C.

In an aspect, the poly(etherimide) comprises repeating units derived from bisphenol A and m-phenylene diamine. In an aspect, the poly(etherimide) comprises a poly(etherimide-siloxane) copolymer.

The poly(etherimide) can be present in an amount of 25 to 95 weight percent, based on the total weight of the composition. Within this range, the poly(etherimide) can be present in an amount of 50 to 95 weight percent, or 75 to 95 weight percent, or 80 to 95 weight percent, or 85 to 95 weight percent. In an aspect, when the poly(etherimide) is a poly(etherimide)-polysiloxane copolymer, the poly(etherimide) can be present in an amount of 25 to 60 weight percent, or 25 to 50 weight percent, or 25 to 45 weight percent, or 35 to 45 weight percent.

In addition to the poly(etherimide), the composition further comprises a polymer different from the poly(etherimide) provided that it is partially miscible with the poly(etherimide). As used herein, the term “partially miscible” means that a blend of the poly(etherimide) and the polymer different from the poly(etherimide) has more than one glass transition temperature (Tg) and shows a multiphasic morphology (observable, for example, by scanning electron microscopy (SEM)). In particular, two polymers which are partially miscible, when blended, exhibit two separate glass transitions between the glass transitions of the individual constituents and have a poly(etherimide) rich phase and a “polymer 2” rich phase, where “polymer 2” refers to the polymer different from the poly(etherimide). In contrast, a “miscible blend” describes polymer blend having a single phase and a single glass transition temperature. Also in contrast, an “immiscible blend” describes a mixture of two or more polymers which cannot be uniformly mixed or blended to form a single phase. Thus, whether the polymer different from the poly(etherimide) satisfies the criteria of “partially miscible” can be determined by analysis of the glass transition behavior of a blend of the poly(etherimide) and the polymer different from the poly(etherimide), for example using differential scanning calorimetry (DSC).

In an aspect, the polymer different from the poly(etherimide) comprises a polyolefin, a poly(aryl ether ketone), or a combination thereof. In an aspect, the polymer different from the poly(etherimide) can be a polyolefin, for example, a poly(ethylene) and in particular a modified poly(ethylene) which has improved compatibility with the poly(etherimide). For example, the polymer different from the poly(etherimide) can be an epoxy-functionalized poly(ethylene).

In an aspect, the polymer different from the poly(etherimide) can be a poly(aryl ether ketone). Poly(aryl ether ketones) are a class of aromatic poly(ketone)s comprising repeating units of formula (10) and formula (11)

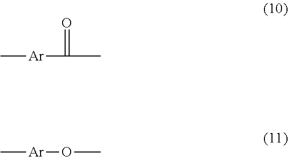

wherein Ar is independently at each occurrence a substituted or unsubstituted, monocyclic or polycyclic aromatic group having 6-30 carbons. Exemplary Ar groups include, but are not limited to, substituted or unsubstituted phenyl, tolyl, naphthyl, and biphenyl. Unsubstituted phenyl is preferred.

In an aspect the poly(aryl ether ketone) can be a poly(ether ether ketone) comprising repeating units of formula (12)

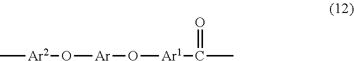

wherein Ar is defined as above, and each of Ar¹ and Ar² are independently at each occurrence a substituted or unsubstituted, monocyclic or polycyclic aromatic group having 6-30 carbons. Ar, Ar¹, and Ar² can be the same as or different from each other. Additionally, two of Ar, Ar¹, and Ar² can be the same as each other and the third can be different. In an aspect Ar, Ar¹, and Ar² are phenyl groups, preferably unsubstituted phenyl groups.

Poly(arylene ether ketone)s are generally known, with many examples being commercially available. Examples of commercially available aromatic poly(ketone)s include those sold under the trade name PEEK™, available from VICTREX.

The polymer different from the poly(etherimide) can be present in an amount of 5 to 70 weight percent, based on the total weight of the composition. Within this range, the polymer different from the poly(etherimide) can be present in an amount of 5 to 65 weight percent, or 5 to 50 weight percent or 5 to 30 weight percent, or 5 to 25 weight percent, or 5 to 10 weight percent, or 20 to 70 weight percent, or 30 to 65 weight percent, or 45 to 65 weight percent. In an aspect, when the poly(etherimide) is a poly(etherimide-siloxane) copolymer, the polymer different from the poly(etherimide) can be present in an amount of 20 to 70 weight percent, or 30 to 65 weight percent, or 45 to 65 weight percent.

In addition to the poly(etherimide) and the polymer different from the poly(etherimide), the thermoplastic composition further comprises a mineral filler. The mineral filler has an average particle size of 0.1 to 10 micrometers, or 0.1 to 7 micrometers, or 0.1 to 5 micrometers, or 0.1 to 2 micrometers, or 0.1 to 1 micrometer. Average particle sizes of less than 3 micrometers are particularly preferred, for example 0.1 to 3 micrometers, or 0.1 to 2 micrometers, or 0.1 to 1 micrometer. Average particle size can be determined, for example, by laser light scattering methods. Average particle size can also be referred to as median particle size or “Dv50”. The mineral filler can generally have any morphology, such as fibrous, modular, needle shaped, lamellar, spherical, or substantially spherical. The mineral filler is also referred to herein as a “microfiller.”

In an aspect, particular mineral fillers that are suitable for use can include, for example, boehmite, kaolin clay, or a combination thereof. In a specific aspect, the mineral filler comprises boehmite. In an aspect, the mineral filler can exclude talc (i.e., talc can be excluded from the present composition). Without wishing to be bound by theory, it may be that the defect area(s) (which are relatively larger cavities) in the partially miscible polymer blends are filled by the with micro-size filler to form more and smaller size cavities, thereby contributing to the impact improvement, Alternatively, or in addition, it may be that the mineral filler can act as a physical compatibilizer that interacts with the poly(etherimide), the polymer that is partially miscible with the poly(etherimide), or both to improve the compatibility of the two phases, thereby contributing to the improvements in impact performance of the resulting composition.

The mineral filler can be present in an amount of 1 to 15 weight percent, based on the total weight of the composition. Within this range, the mineral filler can be present in an amount of 1 to 10 weight percent, or 2 to 9 weight percent, or 2 to 8 weight percent, or 3 to 8 weight percent, or 4 to 8 weight percent, or 5 to 7 weight percent.

In an aspect, the composition comprises 75 to 95 weight percent of the poly(etherimide); 5 to 10 weight percent of the polymer different from the poly(etherimide); and 1 to 10 weight percent of the mineral filler. The poly(etherimide) can comprise repeating units derived from bisphenol A dianhydride and m-phenylene diamine, the polymer different from the poly(etherimide) can comprise a polyolefin, particularly a modified polyolefin, and the mineral filler can comprise kaolin clay, boehmite, or a combination thereof.

In an aspect, the composition comprises 25 to 45 weight percent of the poly(etherimide); 45 to 65 weight percent of the polymer different from the poly(etherimide); and 1 to 10 weight percent of the mineral filler. The poly(etherimide) can be a poly(etherimide-siloxane) copolymer; the polymer different from the poly(etherimide) comprises a poly(aryl ether ketone); and the mineral filler comprises clay, boehmite, or a combination thereof.

In an aspect, the composition can optionally further include an additive. Additives can be selected to achieve a desired property, with the proviso that the additives are also selected so as to not significantly adversely affect a desired property of the composition. Any additives can be mixed at a suitable time during the mixing of the components for forming the composition. Exemplary additives can include, for example, an antioxidant, a thermal stabilizer, a hydrostabilizer, a metal deactivator, a UV stabilizer, a processing aid, a colorant, or a combination thereof. The additives are used in the amounts generally known to be effective. For example, the total amount of any additives (other than any impact modifier or reinforcing agent) can be greater than 0 to 5 weight percent, or 0.001 to 5 weight percent, or 0.01 to 5 weight percent, each based on the total weight of the composition.

The composition can optionally exclude or minimize any components not explicitly disclosed herein. For example, in an aspect, the composition can comprise less than 5 weight percent, or less than 1 weight percent of any polymer other than the poly(etherimide), and the polymer that is partially miscible with the poly(etherimide). In an aspect, the composition can exclude any polymer other than the poly(etherimide), and the polymer that is partially miscible with the poly(etherimide). For example, the composition can exclude a poly(ester). In an aspect, the composition can exclude a polymeric impact modifier, including those derived from an alkenyl aromatic and a conjugated diene (including hydrogenated and unhydrogenated derivatives), and rubber-modified polystyrenes, and the like. Commonly used polymeric impact modifiers are not easily processed at high temperatures such as those needed for processing poly(etherimide) compositions. Degradation of such impact modifiers during processing can result in decreased high heat performance of the resulting compositions. In an aspect, the composition can exclude a compatibilizing agent other than the mineral filler.

The thermoplastic composition can exhibit one or more advantageous properties. In particular, the composition can advantageously exhibit improved impact strength. For example, the thermoplastic composition can exhibit a notched Izod impact strength of greater than 50 MPa, or greater than 75 MPa, as determined according to ASTM D256. The thermoplastic composition can exhibit a notched Izod impact strength that is at least 20%, or at least 50%, or at least 100% greater than a notched Izod impact strength of the same composition without the mineral filler.

In a preferred aspect, the thermoplastic composition includes: 25 to 95 weight percent, preferably of a poly(etherimide); 5 to 70 weight percent of a polymer different from the poly(etherimide), wherein the polymer is a polyolefin, a poly(aryl ether ketone), or a combination thereof, preferably wherein the polymer is an epoxy-functionalized poly(ethylene), a poly(ether ether ketone), or a combination thereof that is partially miscible with the poly(etherimide); and 1 to 15 weight percent of a mineral filler, preferably boehmite, kaolin clay, or a combination thereof, more preferably boehmite, the mineral filler having an average particle size of 0.1 to 5 micrometers, 0.1 to 3 micrometers, or 0.1 to 2 micrometers, or 0.1 to 1 micrometer; wherein weight percent is based on the total weight of the composition, and a molded sample of the thermoplastic composition exhibits a notched Izod impact strength of greater than 50 MPa, or greater than 75 MPa, as determined according to ASTM D256, for example a notched Izod impact strength that is at least 20%, or at least 50%, or at least 100% greater than a notched Izod impact strength of the same composition without the mineral filler. In this aspect, a polymeric impact modifier is excluded from the thermoplastic composition.

The poly(etherimide) preferably comprises repeating units derived from bisphenol A and m-phenylene diamine, or is a poly(etherimide-siloxane) copolymer. Still more preferably, the thermoplastic composition comprises 75 to 95 weight percent of the poly(etherimide); 5 to 10 weight percent of the polymer different from the poly(etherimide); and 1 to 10 weight percent of the mineral filler, or the thermoplastic composition comprises 25 to 45 weight percent of the poly(etherimide); 45 to 65 weight percent of the polymer different from the poly(etherimide); and 1 to 10 weight percent of the mineral filler.

The composition can be prepared by methods that are generally known. For example, the composition can be made by melt-mixing the components of the composition. The composition can further be molded into useful shapes by a variety of techniques such as injection molding, extrusion, rotational molding, blow molding, and thermoforming to form articles.

The improved impact and other desirable properties of the compositions render them useful in a wide variety of applications, such as safety equipment (e.g., protective gear and helmets), housings for various devices, such as medical equipment, analytical equipment, and electronic devices (e.g., computers, tablets, cell phones, and other wearable devices), and interior parts for transportation and mass transportations (e.g., automobiles, trains, buses, ships, and aircraft).

This disclosure is further illustrated by the following examples, which are non-limiting.

### EXAMPLES

Materials used in the following Examples are described in Table 1.

TABLE 1

| Component | Description | Supplier |
|---|---|---|
| PEI | Poly(etherimide) having repeating units derived from bisphenol A and m- | SABIC |
| | phenylene diamine, obtained as ULTEM 1010 | |
| PEI-Si | Poly(etherimide-siloxane) copolymer having repeating units derived from | SABIC |
| | bisphenol A and m-phenylene diamine and bis(3-amino propyl)polydimethyl | |
| | siloxane, having a siloxane content of 20 weight percent, obtained as | |
| | SILTEM 1700 | |
| PET | Poly(ethylene terephthalate) obtained as PET BC112 | SABIC |
| PE-GMA | Epoxy functional polyolefin copolymer having repeating units derived from | Sumitomo |
| | ethylene and glycidyl methacrylate containing 2.6 mol % glycidyl | Chemical |
| | methacrylate and having a weight average molecular weight of 123,000 g/mol | |
| | and a melt index of 3 g/10 minutes, obtained as IGETABOND E | |
| PEEK | Poly(ether ether ketone), CAS Reg. No. 29658-26-2, obtained as PEEK 085P | Panjing Zhongrun |
| LCP | Liquid crystal polymer, obtained as UENO LCP A2500 | UENO |
| Boehmite-1 | Boehmite, having an average particle size of 0.90 μm, obtained as APYRAL | Nabaltec AG |
| | AOH60 | |
| Boehmite-2 | Boehmite, aminosilane treated, having an average particle size of 0.35 μm, | Nabaltec AG |
| | obtained as ACTILOX 200AS1 | |
| Clay | Kaolin clay, having an average particle size of 0.4 μm, obtained as KaMin ™ | KaMin LLC |
| | HG90 | |
| AO | Pentaerythritol tetrakis(3,5-di-tert-butyl-4-hydroxyhydrocinnamate), | BASF |
| | CAS Reg. No. 6683-19-8; obtained as IRGANOX 1010 | |
| TBPP | Tris(2,4-di-tert-butylphenyl) phosphite, CAS Reg. No. 31570-04-4; | BASF |
| | obtained as IRGAFOS 168 | |

Compositions of the following Examples were prepared by compounding on a twin screw extruder. Polymers and additives were blended together and fed by the main feeder. Strands of the compositions were cut into pellets and then dried for molding and physical testing. Table 2 shows the compounding profile that was used.

TABLE 2

| Parameters | Unit | Set Values |
|---|---|---|
| Zone 1 Temp | ° C. | 50 |
| Zone 2 Temp | ° C. | 150-200 |
| Zone 3 Temp | ° C. | 300-320 |
| Zone 4 Temp | ° C. | 320-360 |
| Zone 5 Temp | ° C. | 340-370 |
| Zone 6 Temp | ° C. | 340-370 |
| Zone 7 Temp | ° C. | 340-370 |
| Zone 8 Temp | ° C. | 340-370 |
| Zone 9 Temp | ° C. | 340-370 |
| Zone 10 Temp | ° C. | 340-370 |
| Zone 11 Temp | ° C. | 340-370 |
| Die Temp | ° C. | 340-370 |
| Screw speed | rpm | 400 |
| Throughput | kg/hr | 20-30 |

Table 3 shows the injection molding profile that was used for molding parts suitable for physical testing.

TABLE 3

| Parameters | Unit | Set Values |
|---|---|---|
| Condition: Pre-drying time | Hour | 4-6 |
| Condition: Pre-drying temp | ° C. | 135-150 |
| Hopper temp | ° C. | 70 |
| Zone 1 temp | ° C. | 320-360 |
| Zone 2 temp | ° C. | 340-370 |
| Zone 3 temp | ° C. | 345-380 |
| Nozzle temp | ° C. | 350-385 |
| Mold temp | ° C. | 140-180 |

The molded compositions were subjected to the following physical testing. Melt flow rate (MFR) was determined according to ASTM D1238, where the pellets were pre-dried at 150° C. for 4 hours, and the test was conducted at 337° C. under a 6.7 kilogram load with a dwell time of 300 seconds or at 367° C. under a 6.7 kilogram load with a dwell time of 300 seconds, as indicated in Table 4, below. Flexural properties were tested according to ASTM D790 with a span of 50 millimeters and a test speed of 1.27 millimeters per minute. Impact strength (NII) was tested according to ASTM D256, where the test specimen was notched or unnotched and the pendulum energy for testing was 5 pound force foot (lbf/ft). Heat deflection temperature (HDT) was determined according to ASTM D648, where the test specimen was 3.2 millimeters thick and the stress for testing was 1.82 MPa. Tensile properties were tested according to ASTM D638 using a test speed of 50 millimeters per minute. Glass transition temperature (Tg) is reported in ° C. and was determined using differential scanning calorimetry.

Compositions and test results are shown in Table 4. The amount of each component of the composition is provided in weight percent, based on the total weight of the composition.

TABLE 4

| | Unit | CE1 | CE2 | CE3 | E1 | E2 | CE4 | E3 | E4 | CE5 | CE6 |
|---|---|---|---|---|---|---|---|---|---|---|---|
| Component | | | | | | | | | | | |
| PEI | % | 89.7 | 83.7 | 92.7 | 86.7 | 86.7 | | | | 89.7 | 83.7 |
| PEI—Si | | | | | | | 40 | 37.6 | 37.6 | | |
| PET | % | 10 | 10 | | | | | | | | |
| PE—GMA | % | | | 7 | 7 | 7 | | | | | |
| PEEK | | | | | | | 60 | 56.4 | 56.4 | | |
| LCP | | | | | | | | | | 10 | 10 |
| AO | % | 0.15 | 0.15 | 0.15 | 0.15 | 0.15 | | | | 0.15 | 0.15 |
| TBPP | % | 0.15 | 0.15 | 0.15 | 0.15 | 0.15 | | | | 0.15 | 0.15 |
| Clay | % | | | | 6 | | | 6 | | | |
| Boehmite-1 | % | | 6 | | | 6 | | | | | 6 |
| Boehmite-2 | % | | | | | | | | 6 | | |
| Properties | | | | | | | | | | | |
| Tg | ° C. | 188.7 | 187.5 | −58/218 | −58/217 | −57/217 | 164.3 | 167.5 | 161.9 | 214 | 213 |
| MFR, 337° C./6.7 | g/10 | 50.7 | 55.0 | 14.7 | 8.9 | 11.4 | | | | 23.9 | 27.5 |
| kg | min | | | | | | | | | | |
| MFR, 367° C./6.7 | g/10 | | | | | | 107 | 34.4 | 84.1 | | |
| kg | min | | | | | | | | | | |
| Specific Gravity | | 1.29 | 1.33 | 1.23 | 1.27 | 1.27 | 1.25 | 1.28 | 1.28 | 1.29 | 1.33 |
| Ductility | % | | | | | | 100 | 100 | 100 | | |
| NII | J/m | 36.1 | 34.5 | 158 | 116 | 195 | 222 | 538 | 1530 | 55.5 | 37.8 |
| UNII* | J/m | 1480 | 1220 | 2120 | 2150 | 2150 | 2170 | 2170 | 2170 | 387 | 238 |
| | | | | | (NB) | (NB) | (NB) | (NB) | (NB) | | |
| Tensile Modulus | MPa | 3303 | 3531 | 2713 | 2706 | 2688 | 2523 | 2510 | 2464 | 4181 | 4362 |
| Tensile Stress at | MPa | 92.3 | 113.2 | 68.2 | 73.3 | 73.8 | 43.3 | 34.1 | 40.8 | 90.2 | 76.8 |
| break | | | | | | | | | | | |
| Tensile Elong. at | % | 8.8 | 5.2 | 11.1 | 12.7 | 10.4 | 103.4 | 7.3 | 100.6 | 3.1 | 2.7 |
| break | | | | | | | | | | | |
| Flexural Modulus | MPa | 3430 | 3680 | 2740 | 2670 | 2690 | 2360 | 2290 | 2330 | 3760 | 4020 |
| Flexural Stress | MPa | 170 | 174 | 134 | 126 | 127 | 102 | 82.3 | 102 | 134 | 102 |
| HDT | ° C. | 167 | 165 | 184 | 185 | 186 | 136 | 136 | 137 | 188 | 190 |

*NB = non-break

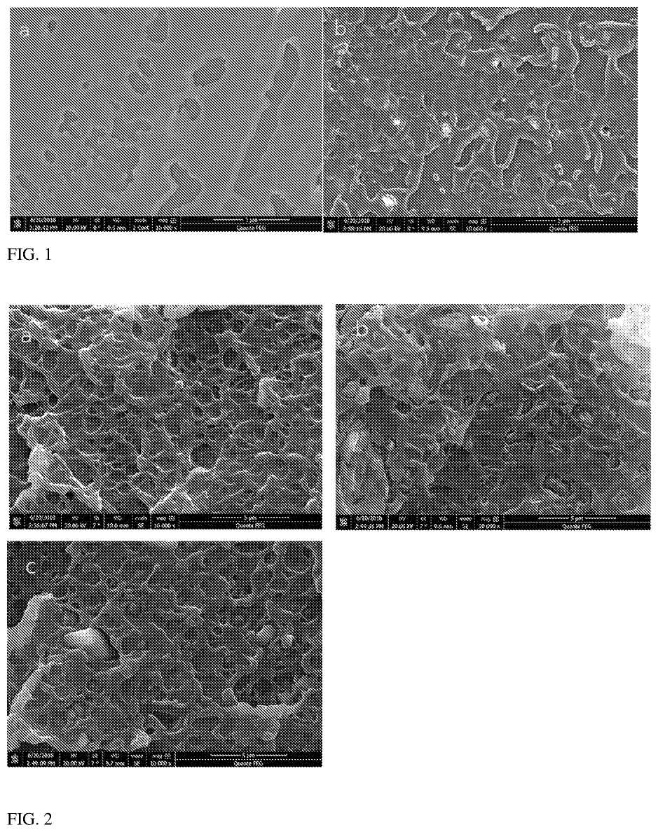

As shown in Table 4, comparative examples 1 and 2 are compositions including PEI and PET with and without microfiller. PEI and PET are fully miscible, as can be seen in scanning electron microscope (SEM) images of FIG. 1 ((a) shows a SEM image for CE1 and (b) shows a SEM image for CE2) which do not show any obvious phase separation. By adding the filler (e.g., boehmite), there is no significant effect on the impact performance of the compositions.

Comparative example 3 and inventive examples 1 to 4 are compositions including PEI and an epoxy-containing olefin copolymer with and without microfiller. The PEI/polyolefin blends are partially miscible, as can be seen in FIG. 2(a). As shown in Table 4, the addition of the microfiller, which, without wishing to be bound by theory, is believed to act as a compatibilizer, improved the impact performance of the compositions significantly, while the thermal properties such as HDT were not affected. FIG. 2(b)-(c) show the SEM images for examples 1-2, respectively.

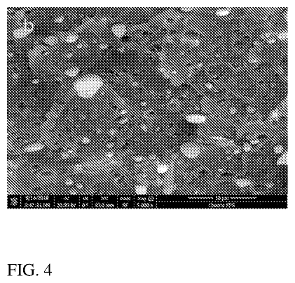

Comparative examples 5 and 6 are compositions including PEI and LCP with and without microfiller. PEI and LCP are fully immiscible, as can be seen in SEM image of FIG. 4(a). As shown in Table 4, adding the microfiller did not improve the impact performance of the composition compared to the composition not having the microfiller.

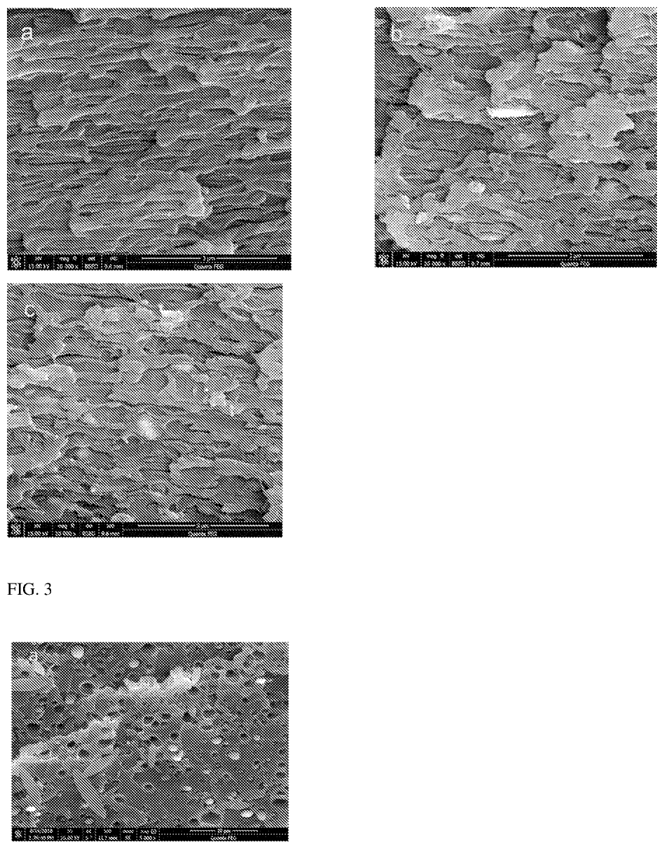

Table 4 also shows compositions including PEI-Si and PEEK (comparative example 4 and examples 3-4). Comparative example 4 does not include a microfiller, and is not a fully miscible composition, as can be seen from the SEM image of FIG. 3(a). With the addition of the microfiller in examples 3 and 4, it can be seen that the impact performance was dramatically improved without sacrificing any heat performance, in particular for the composition including boehmite as the microfiller. FIGS. 3(b) and 3(c) show the SEM images for examples 3 and 4.

Thus, the present inventors have unexpectedly found that the addition of a particular filler into compositions including partially miscible polymer components can provide improved impact strength with essentially no adverse effect to other physical properties of the compositions. A significant improvement is therefore realized by the present compositions.

This disclosure further encompasses the following aspects.

Aspect 1: A thermoplastic composition comprising: 25 to 95 weight percent of a poly(etherimide); 5 to 70 weight percent of a polymer different from the poly(etherimide) that is partially miscible with the poly(etherimide); and 1 to 15 weight percent of a mineral filler having an average particle size of 0.1 to 10 micrometers, or 0.1 to 7 micrometers, or 0.1 to 5 micrometers, or 0.1 to 2 micrometers, or 0.1 to 1 micrometer; wherein weight percent is based on the total weight of the composition.

Aspect 2: The thermoplastic composition of aspect 1, wherein the thermoplastic composition exhibits a notched Izod impact strength of greater than 50 MPa, or greater than 75 MPa, as determined according to ASTM D256.

Aspect 3: The thermoplastic composition of aspect 1 or 2, wherein the thermoplastic composition exhibits a notched Izod impact strength that is at least 20%, or at least 50%, or at least 100% greater than a notched Izod impact strength of the same composition without the mineral filler.

Aspect 4: The thermoplastic composition of any one of aspects 1 to 3, wherein a polymeric impact modifier is excluded from the composition.

Aspect 5: The thermoplastic composition of any one of aspects 1 to 4, wherein the poly(etherimide) comprises repeating units derived from bisphenol A and m-phenylene diamine.

Aspect 6: The thermoplastic composition of any one of aspects 1 to 5, wherein the poly(etherimide) comprises a poly(etherimide-siloxane) copolymer.

Aspect 7: The thermoplastic composition of any one of aspects 1 to 6, wherein the polymer different from the poly(etherimide) comprises a polyolefin, a poly(aryl ether ketone), or a combination thereof, preferably an epoxy-functionalized poly(ethylene), a poly(ether ether ketone), or a combination thereof.

Aspect 8: The thermoplastic composition of any one of aspects 1 to 7, wherein the mineral filler comprises boehmite, kaolin clay, or a combination thereof, preferably boehmite.

Aspect 9: The thermoplastic composition of aspect 1, comprising: 75 to 95 weight percent of the poly(etherimide); 5 to 10 weight percent of the polymer different from the poly(etherimide); and 1 to 10 weight percent of the mineral filler.

Aspect 10: The thermoplastic composition of aspect 9, wherein the poly(etherimide) comprises repeating units derived from bisphenol A dianhydride and m-phenylene diamine; the polymer different from the poly(etherimide) comprises a polyolefin; and the mineral filler comprises clay, boehmite, or a combination thereof.

Aspect 11: The thermoplastic composition of aspect 1, comprising: 25 to 45 weight percent of the poly(etherimide); 45 to 65 weight percent of the polymer different from the poly(etherimide); and 1 to 10 weight percent of the mineral filler.

Aspect 12: The thermoplastic composition of aspect 11, wherein the poly(etherimide) is a poly(etherimide-siloxane) copolymer; the polymer different from the poly(etherimide) comprises a poly(aryl ether ketone); and the mineral filler comprises clay, boehmite, or a combination thereof.

Aspect 13: The thermoplastic composition of any one of aspects 1 to 12, wherein the thermoplastic composition further includes an additive, preferably an antioxidant, a thermal stabilizer, a hydrostabilizer, a metal deactivator, a UV stabilizer, a processing aid, a colorant, or a combination thereof, preferably wherein the additive is present in an amount of greater than 0 to 5 weight percent.

Aspect 14: A method of making the thermoplastic composition of any one of aspects 1 to 13, the method comprising melt-mixing the components of the composition.

Aspect 15: An article comprising the composition of any one of aspects 1 to 13.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some aspects,” “an aspect,” and so forth, means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl,” whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
25 to 95 weight percent of a poly(etherimide);
5 to 70 weight percent of a polymer different from the poly(etherimide) that is partially miscible with the poly(etherimide); and
1 to 15 weight percent of a mineral filler having an average particle size of 0.1 to 10 micrometers;
wherein weight percent is based on the total weight of the composition.

2. The thermoplastic composition of claim 1, wherein the thermoplastic composition exhibits a notched Izod impact strength of greater than 50 MPa, as determined according to ASTM D256.

3. The thermoplastic composition of claim 1, wherein the thermoplastic composition exhibits a notched Izod impact strength that is at least 20% greater than a notched Izod impact strength of the same composition without the mineral filler.

4. The thermoplastic composition of claim 1, wherein a polymeric impact modifier is excluded from the composition.

5. The thermoplastic composition of claim 1, wherein the poly(etherimide) comprises repeating units derived from bisphenol A and m-phenylene diamine.

6. The thermoplastic composition of claim 1, wherein the poly(etherimide) comprises a poly(etherimide-siloxane) copolymer.

7. The thermoplastic composition of claim 1, wherein the polymer different from the poly(etherimide) comprises a polyolefin, a poly(aryl ether ketone), or a combination thereof.

8. The thermoplastic composition of claim 1, wherein the mineral filler comprises boehmite, kaolin clay, or a combination thereof.

9. The thermoplastic composition of claim 1, comprising
75 to 95 weight percent of the poly(etherimide);
5 to 10 weight percent of the polymer different from the poly(etherimide); and
1 to 10 weight percent of the mineral filler.

10. The thermoplastic composition of claim 9, wherein
the poly(etherimide) comprises repeating units derived from bisphenol A dianhydride and m-phenylene diamine;
the polymer different from the poly(etherimide) comprises a polyolefin; and
the mineral filler comprises clay, boehmite, or a combination thereof.

11. The thermoplastic composition of claim 1, comprising
25 to 45 weight percent of the poly(etherimide);
45 to 65 weight percent of the polymer different from the poly(etherimide); and
1 to 10 weight percent of the mineral filler.

12. The thermoplastic composition of claim 11, wherein
the poly(etherimide) is a poly(etherimide-siloxane) copolymer;
the polymer different from the poly(etherimide) comprises a poly(aryl ether ketone); and
the mineral filler comprises clay, boehmite, or a combination thereof.

13. The thermoplastic composition of claim 1, wherein the thermoplastic composition further includes an additive, preferably an antioxidant, a thermal stabilizer, a hydrostabilizer, a metal deactivator, a UV stabilizer, a processing aid, a colorant, or a combination thereof.

14. A method of making the thermoplastic composition of claim 1, the method comprising melt-mixing the components of the composition.

15. An article comprising the composition of claim 1.
